(19) United States
(12) Patent Application Publication
(10) Pub. No.: US 2010/0146280 A1
(43) Pub. Date: Jun. 10, 2010

(54) REMOTE ASSISTING METHOD AND SYSTEM

(75) Inventors: Po-Yuan Teng, Kaohsiung City (TW); Lun-Chia Kuo, Taichung City (TW); Yi-Hsiung Huang, Tainan County (TW); Lee-Chun Ko, Taipei County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: INDUSTRIAL TECHNOLOGY RESEARCH INSTITUTE, Hsinchu (TW)

(21) Appl. No.: 12/466,049

(22) Filed: May 14, 2009

(30) Foreign Application Priority Data
Dec. 10, 2008 (TW) 97148113
Dec. 23, 2008 (CN) 200810184932.0

(51) Int. Cl. H04L 9/32; H04L 9/30

(52) U.S. Cl. 713/175; 380/44; 380/282

(57) ABSTRACT

A remote assisting method is applied in a remote assisting system, which includes a server, a help-asking device and a helping device. The remote assisting method includes the following steps. First, ticket information is encrypted into encrypted ticket information, which is provided to the server, in response to a help-asking event and according to a first key. Next, the encrypted ticket information provided by the help-asking device is decoded into the ticket information according to a second key. Then, the ticket information, generated by decoding, is provided to the helping device such that the helping device can log in the help-asking device and perform a remote assisting operation.

This application claims the benefit of Taiwan application Serial No. 97148113, filed Dec. 10, 2008, the subject matter of which is incorporated herein by reference.

### BACKGROUND

1. Technical Field

The disclosure relates in general to a communication system, and more particularly to a remote assisting system for implementing a remote assisting function.

2. Description of the Related Art

In the modern age in which the technology is changing with each passing day, many communication techniques have been widely applied in many occasions to facilitate the daily life of the human beings. In one occasion, the customer service department of the electronic product provider provides the product operation assistance service for remote users who cannot normally use the electronic products provided therefrom.

In the current technique, which is frequently seen, a remote electronic product user needs to get the operation teachings and assistance from the customer service department through the communication link such as the landline telephone, the mobile telephone or the network. However, it is an important direction to design a more convenient remote assisting system that may be operated more easily according to the current communication technique.

### SUMMARY

The embodiments are directed to a remote assisting system, wherein a help-asking device (i.e., a device operated by a client) provides ticket information to a helping device through a server of the remote assisting system in response to a help-asking event. Thus, the helping device may log in the help-asking device according to the ticket information to assist the help-asking device in eliminating operation problems.

Consistent with embodiments of the present invention, there is further provided a remote assisting method applied in a remote assisting system is provided. The remote assisting system includes a server, a help-asking device and a helping device. The remote assisting method includes the following steps. First, first encrypted ticket information generated by the help-asking device, which encrypts ticket information in response to a help-asking event and according to a first key, is received. Next, the first encrypted ticket information, which is provided by the help-asking device, is decoded into the ticket information according to a second key. Then, the ticket information, obtained by decoding, is provided to the helping device such that the helping device can log in the help-asking device and perform a remote assisting operation.

Consistent with embodiments of the present invention, there is further provided a remote assisting system including a help-asking device, a server and a helping device is provided. The help-asking device having a first key is for encrypting ticket information into first encrypted ticket information in response to a help-asking event and according to the first key. The server having a second key is for decoding the first encrypted ticket information into the ticket information according to the second key, and providing the ticket information. The helping device is for receiving the ticket information provided by the server such that the helping device can log in the help-asking device and perform a remote assisting operation.

Consistent with embodiments of the present invention, there is further provided a remote assisting system for communicating with a helping device is provided. The remote assisting system includes a help-asking device and a server. The help-asking device having a first key is for encrypting ticket information into first encrypted ticket information in response to a help-asking event and according to the first key and providing the first encrypted ticket information. The server having a second key is for decoding the first encrypted ticket information into the ticket information according to the second key and providing the ticket information to the helping device such that the helping device can log in the help-asking device and perform a remote assisting operation.

The invention will become apparent from the following detailed description of the preferred but non-limiting embodiments. The following description is made with reference to the accompanying drawings.

### BRIEF DESCRIPTION OF THE DRAWINGS

FIG. 1 is a block diagram showing a remote assisting system according to an embodiment.

FIG. 2 shows the operation sequence of FIG. 1.

FIG. 3 is another block diagram showing a remote assisting system according to an embodiment.

FIG. 4 shows the operation sequence of FIG. 3.

FIG. 5 is still another block diagram showing a remote assisting system according to an embodiment.

FIG. 6 shows the operation sequence of FIG. 5.

FIG. 7 is yet still another block diagram showing a remote assisting system according to an embodiment.

FIG. 8 shows the operation sequence of FIG. 7.

FIG. 9 is yet still another block diagram showing a remote assisting system according to an embodiment.

FIG. 10 is yet still another block diagram showing a remote assisting system according to an embodiment.

FIG. 11 shows the operation sequence of FIG. 10.

### DETAILED DESCRIPTION

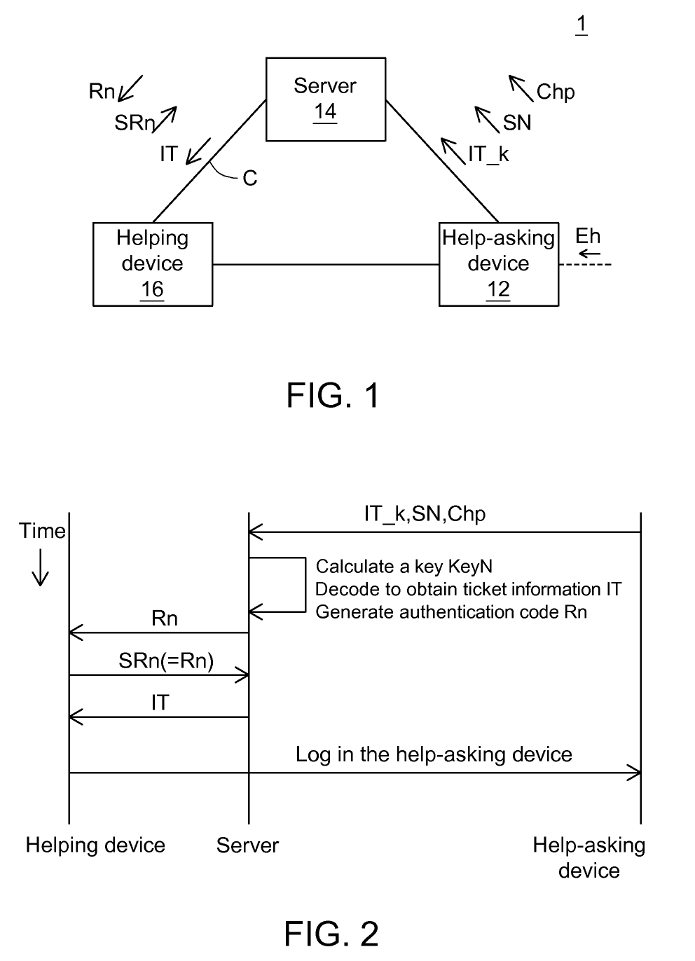

FIG. 1 is a block diagram showing a remote assisting system 1 according to an embodiment of the invention. FIG. 2 shows the operation sequence of FIG. 1. Referring to FIGS. 1 and 2, the remote assisting system 1 includes a help-asking device 12, a server 14 and a helping device 16. For example, the help-asking device 12 is connected to a home appliance apparatus on the network through a home gateway. Therefore, the help-asking device 12 has a remote operation function of performing the corresponding operation in response to an instruction provided through the network and the home gateway. In one example, the electronic home appliance apparatus is a digital television apparatus, for example.

The help-asking device 12 has a key KeyN. The help-asking device 12 encrypts ticket information IT in response to a help-asking event Eh and according to the key KeyN to provide encrypted ticket information IT_k and a help-asking instruction Chp. For example, the ticket information IT_k includes user account information, password information and Internet protocol (IP) address information. The help-asking event Eh is an event generated when the user activates a help-asking control key on a control panel of the help-asking device 12.

The server 14 has a key KeyS. The server 14 decodes the encrypted ticket information IT_k into the ticket information IT in response to the help-asking instruction Chp and according to the key KeyS.

In one example, the help-asking device 12 further includes a device serial number SN and provides the device serial number SN to the server 14 in response to the help-asking event. For example, the key KeyS of the help-asking device 12 and the key KeyN of the server 14 satisfy the following equation:

KeyN=Hash(KeyS∥SN)

Therefore, the server 14 may perform a hash operation to generate the key KeyN according to the key KeyS thereof and the device serial number SN, provided by the help-asking device 12, and thus decode the encrypted ticket information IT_k into the ticket information IT.

The server 14 further provides the ticket information IT, obtained by decoding, to the helping device 16. Thus, the helping device 16 may log in the help-asking device 12 according to the ticket information IT and perform a remote assisting operation.

In one example, the data transmission operation between the server 14 and the helping device 16 is protected according to an authentication code mechanism. In the authentication code mechanism, the server 14 dynamically generates an authentication code Rn and provides the authentication code Rn to the helping device 16 through a specific communication channel C.

For example, the communication channel C may be a network transmission channel and a global system for mobile communication (GSM) communication channel. The authentication code Rn may be transmitted via the communication protocol (e.g., an e-mail, a network audio message, a telephone system audio message, a telephone system short message or the like) used to perform the transmission through the communication channel.

The helping device 16 receives the authentication code Rn and correspondingly returns response information SRn to log in the server 14 when it receives the authentication code Rn. For example, the helping device 16 directly returns the received authentication code Rn as the response information SRn to the server 14 to log in the server 14. After receiving the response information SRn, the server 14 determines that the helping device 16 is successfully authenticated. Thus, the helping device 16 may obtain the ticket information IT in the server 14, and thus log in the help-asking device 12 to assist it in performing the corresponding usage operation.

In this illustrated embodiment, the authentication code Rn, the response information SRn and the ticket information IT are transmitted between the server 14 and the helping device 16 through one communication channel C. However, the remote assisting system 1 of this embodiment is not limited thereto. In another example, the server 14 of this embodiment may also transmit the ticket information IT through multiple channels.

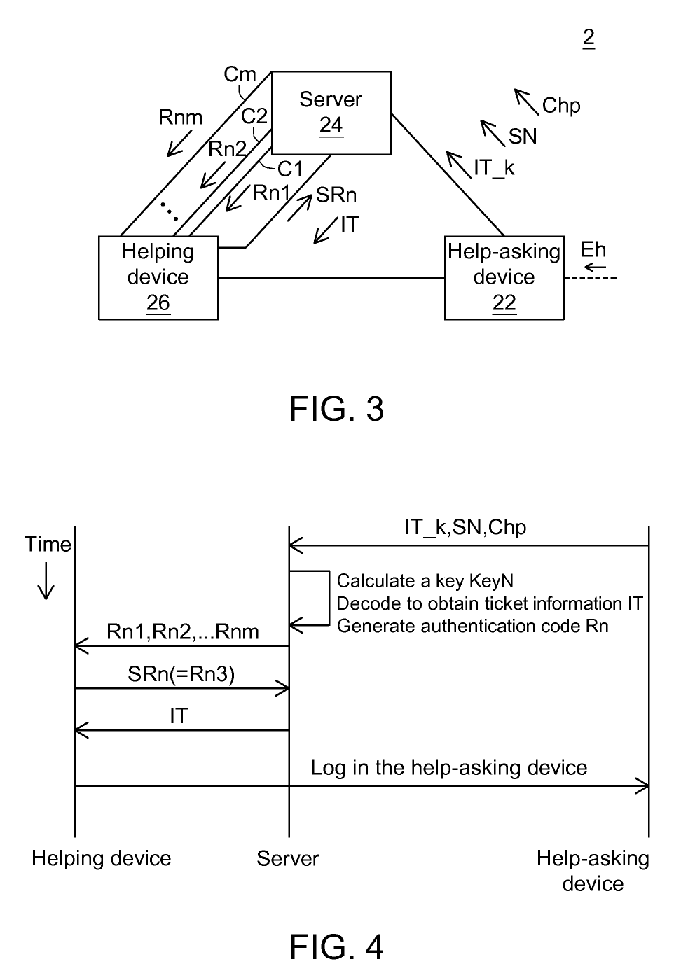

FIG. 3 is another block diagram showing a remote assisting system according to the embodiment of the invention. In this example of FIG. 3, m communication channels C1, C2, . . . , and Cm are disposed between a server 24 and a helping device 26, wherein m is a natural number greater than 1. The server 24 provides authentication codes Rn1 to Rnm to the helping device 26 through the communication channels C1 to Cm.

FIG. 4 shows the operation sequence of FIG. 3. As shown in FIG. 4, for example, the authentication codes Rn1 to Rnm have different data values c. In this example, the helping device 26 may correspondingly generate the response information SRn according to any one subset (e.g., the authentication code {Rn3}, {Rn1, Rn2}, or {Rn1, Rn3} . . . ) of the authentication codes Rn1 to Rnm, and return the response information SRn to the server 24 to complete the authentication operation between the server 24 and the helping device 26.

In this illustrated embodiment, the data transmission operation between the server 24 and the helping device 26 is protected using the authentication code mechanism. However, the remote assisting system 1 of this embodiment is not limited thereto, and may further protect the data transmission operation between the server 24 and the helping device 26 using any other mechanism.

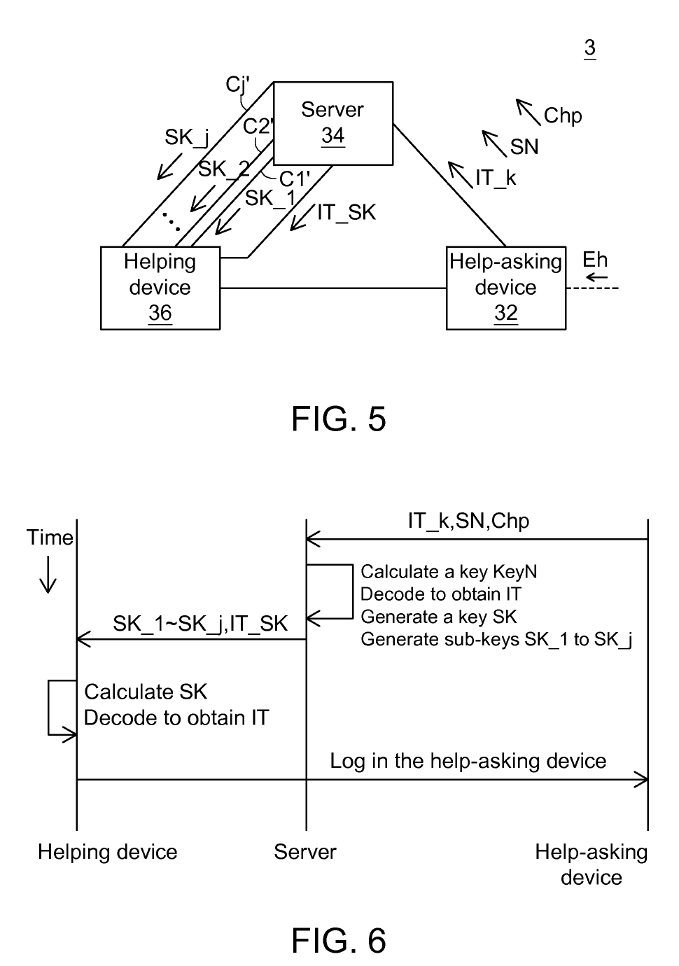

FIG. 5 is still another block diagram showing a remote assisting system according to the embodiment of the invention. FIG. 6 shows the operation sequence of FIG. 5. Referring to FIGS. 5 and 6, the data transmission operation between a server 34 and a helping device 36 is protected through a secret sharing mechanism. The server 34 encrypts the ticket information IT into encrypted ticket information IT_SK according to a key SK. For example, the encrypted ticket information IT_SK includes an exclusive OR result of the account information with the key SK, an exclusive OR result of the password information with the key SK, the IP information, the time parameter information and the hash authentication information of the password information, the account information, and the IP information.

The server 34 further divides the key SK into j sub-keys SK_1, SK_2, . . . , SK_j, and obtains the key SK according to i sub-keys among the j sub-keys SK_1 to SK_j, wherein j is a natural number greater than 1, and i is a natural number smaller than j.

The server 34 provides the sub-keys SK_1 to SK_j and the encrypted ticket information IT_SK to the helping device 36 through the j communication channels C1′, C2′, . . . , and Cj′, respectively.

For example, the server 34 decomposes the key SK according to Shamir's secret sharing mechanism. Let the key SK have the value 1234, and j and i are respectively equal to 6 and 3. The server 34 further dynamically sets the parameter a1 to be equal to 166 and the parameter a2 to be equal to 94. In this case, for example, the server 34 obtains a polynomial:

ƒ(x)=1234+a₁x+a₂x²=1234+166x+94x²

The following conditions are respectively substituted into the polynomial to obtain six solution sets (x,f(x)) of (1,1494), (2,1942), (3,2578), (4,3402), (5,4414) and (6,5614):
x=1; x=2; x=3; x=4; x=5; x=6.

The six solution sets, obtained after decomposition, respectively serve as the sub-keys SK_1 to SK_6, which are respectively provided to the helping device 36 through the corresponding communication channels. It is assumed that the helping device 36 receives the sub-keys SK_2, SK_5 and SK_6, then the helping device 36 may reproduce to obtain the key SK according to the second, fifth and sixth sub-keys through the following equations:

$$SK\_ 2 = ( {x}_{0} , {y}_{0} ) = ( 2 , 1942 ) ;$$

$$SK\_ 4 = ( {x}_{1} , {y}_{1} ) ( 4 , 3402 ) ;$$

$$SK\_ 5 = ( {x}_{2} , {y}_{2} ) = ( 5 , 5614 ) ;$$

$${l}_{0} ( x ) = \frac{x - {x}_{1}}{{x}_{0} - {x}_{1}} \times \frac{x - {x}_{2}}{{x}_{0} - {x}_{2}} = \frac{x - 4}{2 - 4} \times \frac{x - 5}{2 - 5} = \frac{1}{6} {x}^{2} - 1 \frac{1}{2} x + 3 \frac{1}{3}$$

$${l}_{1} ( x ) = \frac{x - {x}_{0}}{{x}_{1} - {x}_{0}} \times \frac{x - {x}_{2}}{{x}_{1} - {x}_{2}} = \frac{x - 2}{4 - 2} \times \frac{x - 5}{4 - 5} = - \frac{1}{2} {x}^{2} + 3 \frac{1}{2} x - 5$$

$${l}_{3} ( x ) = \frac{x - {x}_{0}}{{x}_{2} - {x}_{0}} \times \frac{x - {x}_{1}}{{x}_{2} - {x}_{1}} = \frac{x - 2}{5 - 2} \times \frac{x - 4}{5 - 4} = \frac{1}{3} {x}^{2} - 2 x + 2 \frac{2}{3}$$

$$\begin{matrix}f ( x ) = {\sum }_{z = 0}^{2} {y}_{z} \times {l}_{z} ( x ) \\ = 1942 \{ \frac{1}{6} {x}^{2} - 1 \frac{1}{2} x + 3 \frac{1}{3} \} + 3402 \{ - \frac{1}{2} {x}^{2} + 3 \frac{1}{2} x - 5 \} + \\ 4414 \{ \frac{1}{3} {x}^{2} - 2 x + 2 \frac{2}{3} \} \\ = 1234 + 166 x + 94 {x}^{2} = SK + 166 x + 94 {x}^{2}\end{matrix}$$

Thus, the helping device 36 may obtain the key SK according to the operation and thus decode the encrypted ticket information IT_SK into the ticket information IT.

In this embodiment, the operation of only one Shamir's secret sharing mechanism is illustrated as an example. However, the data transmission between the server 34 and the helping device 36 needs not to be protected using the Shamir's secret sharing mechanism, and the key SK, i and j are also not restricted to the settings of the above-mentioned example, and may also be other values satisfying the corresponding secret sharing mechanism.

In this illustrated embodiment, the help-asking device 12 provides the authentication code Rn to the helping device 16 to authenticate the identification of the helping device 16 logging in the help-asking device 12. However, the remote assisting system 1 of this embodiment is not limited thereto.

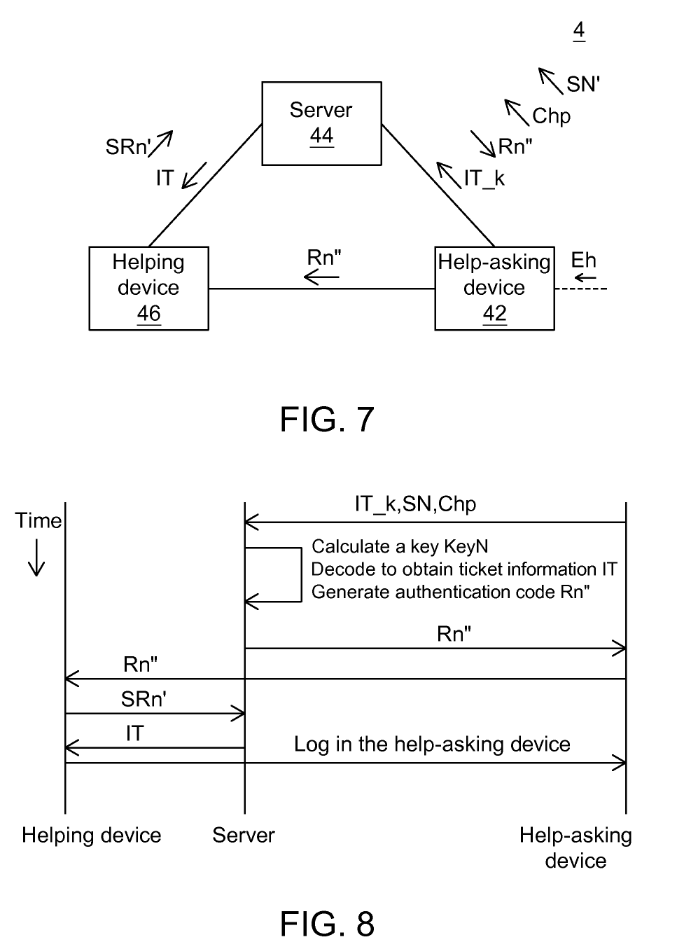

FIG. 7 is yet still another block diagram showing a remote assisting system according to the embodiment of the invention. FIG. 8 shows the operation sequence of FIG. 7. In yet still another example shown in FIGS. 7 and 8, a server 44 provides an authentication code Rn″ to a help-asking device 42, and provides the authentication code Rn″ to a helping device 46 through the help-asking device 42. Thereafter, the helping device 46 generates and outputs return information SRn′ to the server 44 to log in the server 44 according to the authentication code Rn″ provided by the help-asking device 42. Therefore, the helping device 46 may also obtain the ticket information IT from the server 44 to log in the help-asking device 42.

In this illustrated embodiment, the encryption between the server 14 and the help-asking device 12 is performed according to the fixed keys KeyN and KeyS. However, the encryption operation between the server 14 and the help-asking device 12 is not limited thereto.

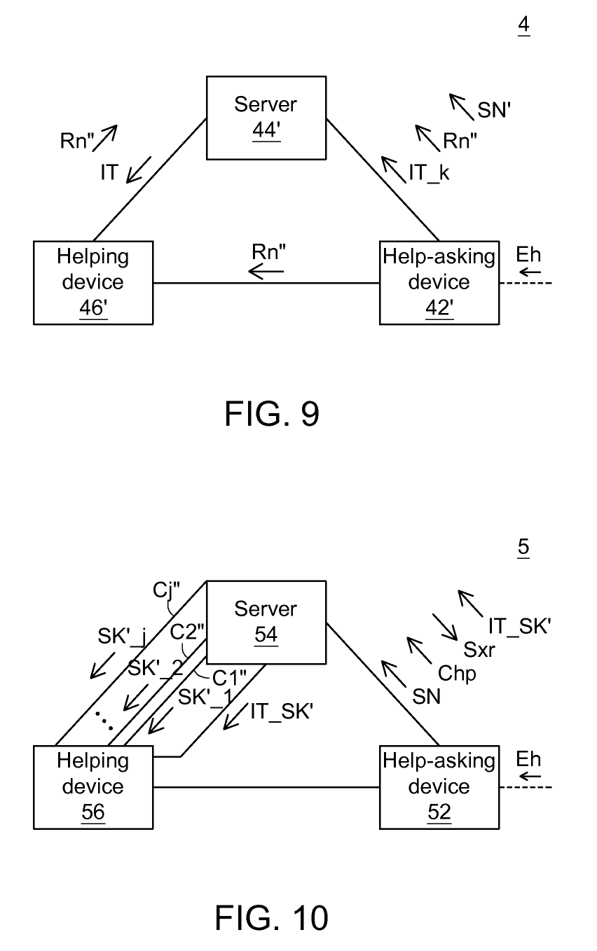

FIG. 9 is yet still another block diagram showing a remote assisting system according to the embodiment of the invention. In yet still another example shown in FIG. 9, the authentication code Rn″ is generated by a help-asking device 42′ and is provided to a server 44′ and a helping device 46′. Thereafter, the helping device 46′ provides the authentication code Rn″ to the server 44′ to obtain the ticket information IT and log in the help-asking device 42′.

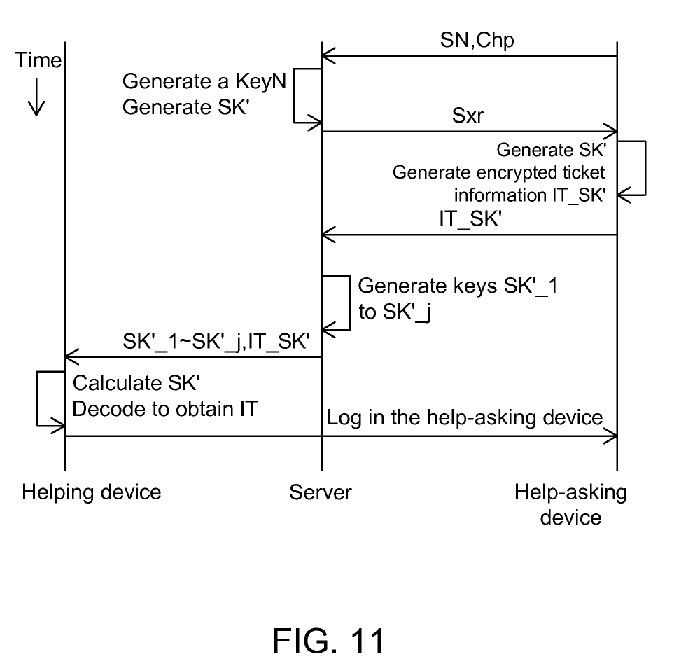

FIG. 10 is yet still another block diagram showing a remote assisting system according to the embodiment of the invention. FIG. 11 shows the operation sequence of FIG. 10. In yet still another example shown in FIGS. 10 and 11, after a server 54 obtains the key KeyN according to the device serial number SN, the server 54 further dynamically generates a dynamic key SK′ and provides an exclusive OR result Sxr of the dynamic key SK′ with the key KeyN to a help-asking device 52. Thus, the help-asking device 52 may obtain the dynamic key SK′ according to the exclusive OR result Sxr, and thus encrypt the ticket information IT and provide the encrypted ticket information IT_SK′ to the server 54. In one example, the server 54 further provides time parameter information and hash authentication information of the time parameter and the dynamic key SK to the help-asking device 52 to authenticate the dynamic key SK.

Next, the server 54 performs the operation substantially the same as that performed by the server 34 to provide the encrypted ticket information IT_SK′ to a helping device 56 through the Shamir's secret sharing mechanism. Thus, the helping device 56 may obtain the ticket information IT_SK′ and log in the help-asking device 52 according to the ticket information IT_SK′.

In this illustrated embodiment, the encryption protection of the communication transmission between the help-asking device 12 and the server 14 is performed according to the keys generated using the hash operation and the symmetrical encryption mechanism. However, the communication transmission between the help-asking device 12 and the server 14 of this embodiment is not limited thereto. In another example, the encryption protection of the transmission between the help-asking device 12 and the server 14 may also be performed through a public key password system.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A remote assisting method applied in a remote assisting system, which comprises a server, a help-asking device and a helping device, the remote assisting method comprising the steps of:
(a) receiving first encrypted ticket information generated by the help-asking device, which encrypts ticket information in response to a help-asking event and according to a first key;
(b) decoding the first encrypted ticket information, which is provided by the help-asking device, into the ticket information according to a second key; and
(c) providing the ticket information, obtained by decoding, to the helping device such that the helping device can log in the help-asking device and perform a remote assisting operation based on the ticket information.

2. The method according to claim 1, wherein:
the step (a) further comprises:
receiving device serial number information generated by the help-asking device; and
the step (b) further comprises:
(b1) performing a hash operation to obtain the first key according to the device serial number information and the second key; and
(b2) decoding the first encrypted ticket information into the ticket information according to the first key.

3. The method according to claim 1, further comprising the steps of:
(d) generating authentication information;
(e) transmitting the authentication information to the helping device through a single channel, wherein the helping device returns response information according to the authentication information; and
(f) judging whether the response information is received or not to judge whether the helping device has been successfully authenticated or not, and performing the step (c) if yes.

4. The method according to claim 1, further comprising the steps of:
(d) generating authentication information;
(e) transmitting the authentication information to the helping device through multiple channels, wherein the helping device returns response information according to the authentication information; and
(f) judging whether the response information is received or not to judge whether the helping device has been successfully authenticated or not, and performing the step (c) if yes.

5. The method according to claim 1, further comprising the steps of:
(d) generating authentication information;
(e) providing the authentication information to the helping device through the help-asking device, wherein the helping device returns response information according to the authentication information; and
(f) judging whether the response information is received or not to judge whether the helping device has been successfully authenticated or not, and performing the step (c) if yes.

6. The method according to claim 1, wherein the step (c) comprises:
(c1) generating a third key and encrypting the ticket information into second encrypted ticket information according to the third key;
(c2) decomposing the third key into N pieces of decomposed key information according to a secret sharing mechanism, wherein N is a natural number greater than 1; and
(c3) transmitting the N pieces of decomposed key information and the second encrypted ticket information to the helping device through N communication channels.

7. The method according to claim 6, wherein the helping device synthesizes at least M pieces of decomposed key information among the N pieces of decomposed key information to obtain the third key, and decodes the second encrypted ticket information into the ticket information according to the third key, wherein M is a natural number smaller than N.

8. The method according to claim 1, further comprising the steps of:
(d) generating authentication information;
(e) providing the authentication information to the help-asking device;
(f) providing the authentication information, received by the help-asking device, to the helping device, wherein the helping device provides response information to the server according to the authentication information; and
(g) judging whether the response information is received or not to judge whether the helping device has been successfully authenticated or not, and performing the step (c) if yes.

9. The method according to claim 1, wherein the first key is a public key.

10. A remote assisting system, comprising:
a help-asking device, having a first key, for encrypting ticket information into first encrypted ticket information in response to a help-asking event and according to the first key;
a server, having a second key, for decoding the first encrypted ticket information into the ticket information according to the second key, and providing the ticket information; and
a helping device for receiving the ticket information provided by the server such that the helping device can log in the help-asking device and perform a remote assisting operation.

11. The system according to claim 10, wherein:
the help-asking device further generates device serial number information and provides the device serial number information to the server; and
the server performs a hash operation to obtain the first key according to the device serial number information and the second key, and the server further decodes the first encrypted ticket information into the ticket information according to the first key.

12. The system according to claim 10, wherein:
the server further generates authentication information, and transmits the authentication information to the helping device through a single channel, and the helping device returns response information according to the authentication information; and
the server further judges whether the response information is received or not to judge whether the helping device has been successfully authenticated or not, wherein when the server receives the response information, the server judges that the helping device is successfully authenticated and provides the ticket information to the helping device.

13. The system according to claim 10, wherein:
the server generates authentication information and transmits the authentication information to the helping device through multiple channels, and the helping device returns response information according to the authentication information; and
the server further judges whether the response information is received or not to judge whether the helping device has been successfully authenticated or not, wherein when the server receives the response information, the server judges that the helping device is successfully authenticated and provides the ticket information to the helping device.

14. The system according to claim 10, wherein:
authentication information is generated and provided to the helping device through the help-asking device, and the helping device returns response information according to the authentication information; and
the server further judges whether the response information is received or not to judge whether the helping device has been successfully authenticated or not, wherein when the server receives the response information, the server judges that the helping device is successfully authenticated and provides the ticket information to the helping device; and
the authentication information is generated by the server or the help-asking device.

15. The system according to claim 10, wherein:
the server generates a third key and encrypts the ticket information into second encrypted ticket information according to the third key;
the server further decomposes the third key into N pieces of decomposed key information according to a secret sharing mechanism, wherein N is a natural number greater than 1; and
the server further transmits the N pieces of decomposed key information and the second encrypted ticket information to the helping device through N communication channels.

16. The system according to claim 15, wherein the helping device synthesizes at least M pieces of decomposed key information among the N pieces of decomposed key information into the third key, and decodes the second encrypted ticket information into the ticket information according to the third key, wherein M is a natural number smaller than N.

17. The system according to claim 10, wherein:
the server further generates authentication information and provides the authentication information to the help-asking device;
the help-asking device provides the authentication information to the helping device, and the helping device provides response information to the server according to the authentication information; and
the server further judges whether the response information is received or not to judge whether the helping device has been successfully authenticated, wherein when the server receives the response information, the server judges that the helping device is successfully authenticated and provides the ticket information to the helping device.

18. A remote assisting system for communicating with a helping device, the remote assisting system comprising:
a help-asking device, having a first key, for encrypting ticket information into first encrypted ticket information in response to a help-asking event and according to the first key and providing the first encrypted ticket information; and
a server, having a second key, for decoding the first encrypted ticket information into the ticket information according to the second key and providing the ticket information to the helping device such that the helping device can log in the help-asking device and perform a remote assisting operation.

19. The system according to claim 18, wherein:
the help-asking device further provides device serial number information to the server; and
the server performs a hash operation to obtain the first key according to the device serial number information and the second key, and the server further decodes the first encrypted ticket information into the ticket information according to the first key.

20. The system according to claim 18, wherein:
the server further generates authentication information and transmits the authentication information to the helping device through a single channel, wherein the helping device returns response information according to the authentication information; and
the server further judges whether the response information is received or not to judge whether the helping device has been successfully authenticated, wherein when the server receives the response information, the server judges that the helping device is successfully authenticated and provides the ticket information to the helping device.

21. The system according to claim 18, wherein:
the server further generates authentication information and transmits the authentication information to the helping device through multiple channels, and the helping device returns response information according to the authentication information; and
the server further judges whether the response information is received or not to judge whether the helping device has been successfully authenticated or not, wherein when the server receives the response information, the server judges that the helping device is successfully authenticated and provides the ticket information to the helping device.

22. The system according to claim 18, wherein:
authentication information is generated and provided to the helping device through the help-asking device, and the helping device returns response information according to the authentication information;
the server further judges whether the response information is received or not to judge whether the helping device has been successfully authenticated or not, wherein when the server receives the response information, the server judges that the helping device is successfully authenticated and provides the ticket information to the helping device; and
the authentication information is generated by the server or the help-asking device.

23. The system according to claim 18, wherein:
the server generates a third key and encrypts the ticket information into second encrypted ticket information according to the third key;
the server further decomposes the third key into N pieces of decomposed key information according to a secret sharing mechanism, wherein N is a natural number greater than 1; and
the server further transmits the N pieces of decomposed key information and the second encrypted ticket information to the helping device through N communication channels.

24. The system according to claim 23, wherein the helping device synthesizes at least M pieces of decomposed key information among the N pieces of decomposed key information into the third key, and decodes the second encrypted ticket information into the ticket information according to the third key, wherein M is a natural number smaller than N.

25. The system according to claim 18, wherein:
the server further generates authentication information and provides the authentication information to the help-asking device;
the help-asking device provides the authentication information to the helping device, and the helping device provides response information to the server according to the authentication information; and
the server further judges whether the response information is received or not to judge whether the helping device has been successfully authenticated, wherein when the server receives the response information, the server judges that the helping device is successfully authenticated and provides the ticket information to the helping device.
